(19) United States
(12) Patent Application Publication
(10) Pub. No.: US 2008/0106097 A1
(43) Pub. Date: May 8, 2008

(54) Method of attaching tubing to a metal fitting

(75) Inventor: Paul Robert Homrich, Maybee, MI (US)

Correspondence Address: CARLSON, GASKEY & OLDS, P.C., 400 WEST MAPLE ROAD, SUITE 350, BIRMINGHAM, MI, 48009, US

(73) Assignee: Brass Craft Manufacturing Company

(21) Appl. No.: 11/593,843

(22) Filed: Nov. 7, 2006

(51) Int. Cl. F16L 19/08

(52) U.S. Cl. 285/382

(57) ABSTRACT

A fluid connection for connecting a tubing, such as a gas tubing for a hot water tank burner, to a metal fitting includes a deformed outer portion of the fitting. In particular, a recess is defined between radially inner and outer portions of the fitting, and the tubing is inserted into that recess. The inner portion of the fitting extends into an inner bore of the tubing to provide support at the inner bore. The outer portion of the fitting is then deformed radially inwardly to secure the tube to the fitting.

### BACKGROUND OF THE INVENTION

This application relates to a method and structure for attaching a tubing to a metal fitting by deforming a portion of the metal fitting.

Metal fittings are utilized as connections in a number of fluid flow applications. In one common application, fluid tubing, which may be corrugated, is welded to a metal fitting.

One application for such a connection is to connect a source of gas through gas tubing to a burner in a hot water tank. The use of the welded connection has made replacement complex. Also, challenges exist with welding the two distinct metals of the tubing and metal fitting.

### SUMMARY OF THE INVENTION

In a disclosed embodiment of this invention, a fluid tubing fits into a recess in a fitting. The fitting has a portion extending into the tubing, and providing support within an inner bore of the tubing. The recess is defined by this inner portion, and an outer portion of the fitting.

The tubing is inserted into the recess, and the outer portion is then deformed to entrap the tube. In disclosed features, the inner portion of the fitting may have an outer peripheral surface which is structured to provide a locking and seal point for the tubing when the outermost portion is deformed downwardly onto the tubing. In one embodiment this may be a raised surface on the outer periphery of the inner portion of the fitting. In a second embodiment, there is a flared inner portion to the tubing, and a mating flared surface at an end of the recess. With either embodiment, a separate seal may be included

With either embodiment, the present invention provides a simple method of attaching a tubing to a fitting, and which may be easily utilized no matter the material of the two components.

These and other features of the present invention can be best understood from the following specification and drawings, the following of which is a brief description.

### BRIEF DESCRIPTION OF THE DRAWINGS

FIG. 1A schematically shows an environment for a fluid connection according to this invention.

FIG. 1B shows a first step in forming the FIG. 1A embodiment.

FIG. 1C shows a subsequent step.

FIG. 2A shows a second embodiment.

FIG. 2B shows a first step in forming the second embodiment.

FIG. 2C shows a subsequent step.

FIG. 3 shows another embodiment.

### DETAILED DESCRIPTION OF THE PREFERRED EMBODIMENT

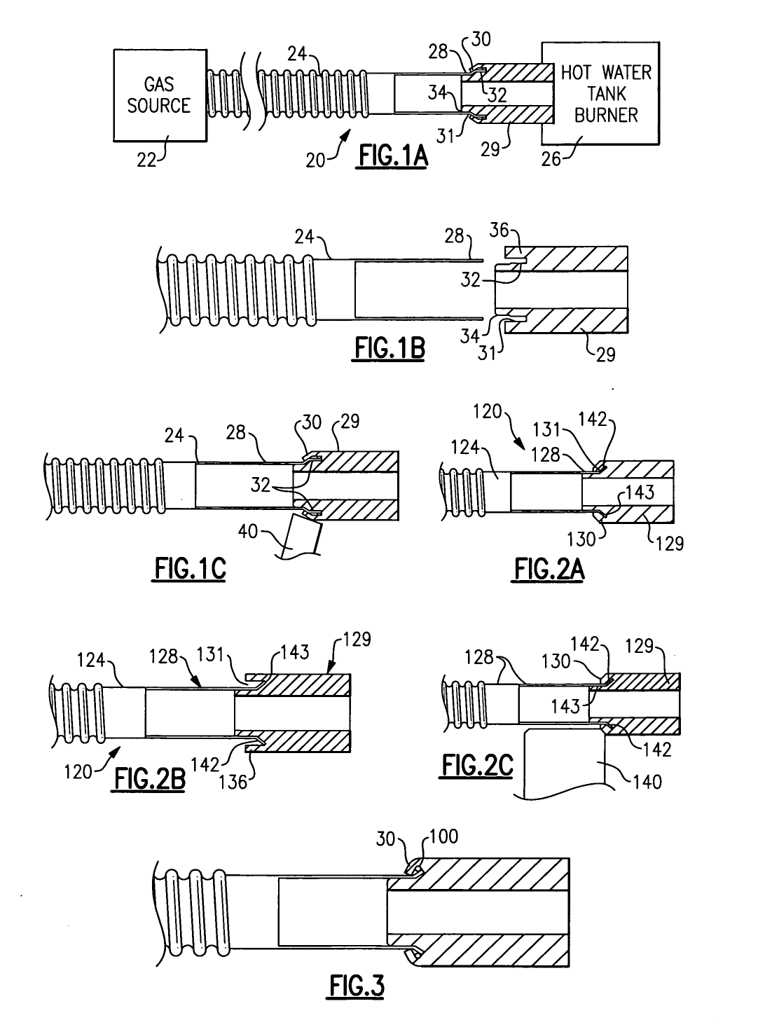

An arrangement 20 is illustrated in FIG. 1A for communicating a source of gas 22, such as natural gas through a fluid tubing 24 and to a hot water tank burner 26. In this embodiment, a fitting 29, which may be formed of brass, steel, or other metals, secures the tubing 24 to the burner 26. The tubing 24 has corrugations, but a generally cylindrical forward end 28. As shown, an end 30 of an outer portion of the fitting 29 is deformed inwardly to trap the forward end 28 of the tubing within a recess 31. At the same time, an inner portion 34 of the fitting 29 fits within the tubing forward end 28, and provides support at the forward end.

As shown in FIG. 1B, the recess 31 includes a raised portion 32 and a generally forward extending outer portion 36, prior to its deformation. The tube 24 is inserted with forward end 28 in the recess 31.

As shown in FIG. 1C, a tool 40 is then utilized to inelastically deform the outer portion 36 radially inwardly against the forward end. The forward end is trapped on the raised portion 32, and a seal is provided, securing the tubing 24 to the fitting 29. This connection provides a very reliable connection between two components, even if they are of dissimilar materials. Moreover, the present invention provides a relatively simple way of connecting the fitting and tubing.

As shown in FIG. 2A, in another embodiment 120, the forward end 128 of the tube 124 has a flared end 142. The flared end 142 is associated with mating flared portion 143 of the recess 131. Again, the outer portion 130 is deformed to entrap the forward portion 128 in the recess 131.

As shown in FIG. 2B, when the forward portion 128 is initially inserted into the recess 131 the outer portion 136 is not yet deformed. The flared portion 142 is moved against the mating portion 143.

As shown in FIG. 2C, a tool 40 inelastically deforms the outer portion 136 against the forward end 128. The flared portion 142 is forced against the mating portion 143, and a seal and secure connection is achieved.

As shown in FIG. 3, a material such as soft cooper ring or other resilient seal 100 (such as TALC) could be inserted to aid in sealing. Such a seal could be used with either the FIG. 1 or the FIG. 2 embodiment.

The present invention thus provides simple methods of attaching a tubing, such as a gas tube for a hot water tank burner, to a metallic fitting.

Although preferred embodiments of this invention have been disclosed, a worker of ordinary skill in this art would recognize that certain modifications would come within the scope of this invention. For that reason, the following claims should be studied to determine the true scope and content of this invention.

What is claimed is:

1. A fluid connection comprising:
tubing having a forward portion extending forwardly into a recess in a fitting, said recess being defined between a radially inner portion and a radially outer portion of said fitting, with said radially inner portion extending into an inner bore of said tubing to support said tubing; and
said radially outer portion of said fitting being inelastically deformed radially inwardly against said tubing to secure and seal said tubing to said fitting.

2. The fluid connection as set forth in claim 1, wherein an outer surface of said radially inner portion has a raised portion against which said tubing is deformed to secure said tubing and provide said seal.

3. The fluid connection as set forth in claim 2, wherein said raised portion is formed on a cylindrical outer surface of said radially inner portion.

4. The fluid connection as set forth in claim 2, wherein said raised portion is a generally flared end of said recess, and said tubing having a mating flared inner end.

5. The fluid connection as set forth in claim 1, wherein said tubing has corrugation at locations removed from said forward portion.

6. The fluid connection as set forth in claim 1, wherein a seal is placed between said radially outer portion and said forward portion.

7. A gas supply connection comprising:
a gas source for supplying gas into a tubing, said tubing being connected to a fitting;
said fitting for communicating gas from said tubing into a hot water tank burner; and
said fitting connected to said tubing with a forward portion of said tubing extending forwardly into a recess in said fitting, said recess being defined between a radially inner portion and a radially outer portion of said fitting, with said radially inner portion extending into an inner bore of said tubing to support said tubing, said radially outer portion of said fitting being inelastically deformed radially inwardly against said tubing to secure and seal said tubing to said fitting

8. The gas supply connection as set forth in claim 7, wherein an outer surface of said radially inner portion has a raised portion against which said tubing is deformed to secure said tubing and provide said seal.

9. The gas supply connection as set forth in claim 8, wherein said raised portion is formed on a cylindrical outer surface of said radially inner portion.

10. The gas supply connection as set forth in claim 8, wherein said raised portion is a generally flared end of said recess, and said fluid tubing having a mating flared inner end.

11. The gas supply connection as set forth in claim 7, wherein said tubing has corrugation at locations removed from said forward portion.

12. The gas supply connection as set forth in claim 7, wherein a seal is placed between said radially outer portion and said forward portion.

13. A method of connecting a tubing to a fitting including the steps of:
providing a fitting with a recess defined between a radially inner portion and a radially outer portion;
inserting a forward end of said tubing into said recess, with said radially inner portion being received within an inner bore of said tubing to support said tubing; and
inelastically deforming said radially outer portion radially inwardly against said tubing to secure said tubing to said fitting.

14. The method as set forth in claim 13, further including the steps of providing a raised portion on an outer surface of said radially inner portion, and the deformation of said radially outer portion forcing said tubing against said raised portion.
